(19) United States
(12) Patent Application Publication
(10) Pub. No.: US 2016/0128066 A1
(43) Pub. Date: May 5, 2016

(54) METHOD OF ALLOCATING RESOURCE TO D2D LINK, AND TRANSMITTING AND RECEIVING DATA THROUGH D2D LINK

(71) Applicant: ELECTRONICS AND TELECOMMUNICATIONS RESEARCH INSTITUTE, Daejeon (KR)

(72) Inventors: SoonGi PARK, Daejeon (KR); Eun Seon CHO, Daejeon (KR); Yeon Seung SHIN, Daejeon (KR); Pyeong Jung SONG, Daejeon (KR)

(73) Assignee: ELECTRONICS AND TELECOMMUNICATIONS RESEARCH INSTITUTE, Daejeon (KR)

(21) Appl. No.: 14/740,550

(22) Filed: Jun. 16, 2015

(30) Foreign Application Priority Data
Oct. 29, 2014 (KR) 10-2014-0148691

(51) Int. Cl. H04W 72/04; H04W 76/02; H04W 16/14; H04B 17/309

(52) U.S. Cl. CPC H04W 72/0453; H04B 17/309; H04W 76/023; H04W 16/14; H04W 92/18

(57) ABSTRACT

Disclosed are a method for allocating a resource to a D2D link of a base station, including determining a D2D link resource to be allocated to the D2D link among cellular resources of the base station, and transmitting uplink control information including information on the D2D link resource to at least two terminals which are connected by the D2D link among a plurality of cellular terminals connected to the base station, and a method for transmitting/receiving data to and from a terminal, including: searching for a white space of cellular resources; transmitting a search result for the white space to a base station of coverage to which the terminal belongs; receiving resource information determined depending on the search result; and transmitting/receiving data to and from the adjacent terminals through the D2D link based on the resource information.

### CROSS-REFERENCE TO RELATED APPLICATION

This application claims priority to and the benefit of Korean Patent Application No. 10-2014-0148691 filed in the Korean Intellectual Property Office on Oct. 29, 2014, the entire contents of which are incorporated herein by reference.

### BACKGROUND OF THE INVENTION

(a) Field of the Invention

The present invention relates to a method for allocating a resource to a D2D link, by a base station, and a method for transmitting and receiving data through a D2D link, by a terminal.

(b) Description of the Related Art

Generally, a device to device (D2D) technology is developed and standardized in an Industrial Scientific and Medical (ISM) band such as WiFi direct and Bluetooth. Recently, however, in a cellular system belonging to a licensed band, technology development and standardization for supporting D2D communication have been progressed.

When D2D communication is made between adjacent user equipment (UE) in the cellular system, a load of a base station may be dispersed and short range transmission may be made to reduce power consumption of the terminal and reduce a transmission delay. In the viewpoint of the overall system, it is possible to improve frequency use efficiency by spatially reusing cellular radio resources in the D2D communication.

However, when the radio resources of the cellular system are used in the D2D communication, interference is an inevitable problem. When the interference is not appropriately controlled, there may be a problem in basic functions of the existing cellular system as well as the D2D communication.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a method of allocating resources and transmitting and receiving D2D data between UEs having advantages of efficiently allocating some of cellular resources for D2D communication between the UEs.

An exemplary embodiment of the present invention provides a method for allocating, by a base station, a resource to a D2D link. The method for allocating a resource includes: determining a D2D link resource to be allocated to the D2D link among cellular resources of the base station; and transmitting uplink control information including information on the D2D link resource to at least two terminals which are connected by the D2D link among a plurality of cellular terminals connected to the base station.

The determining may include: instructing a first terminal of the at least two terminals to search for a white space of the cellular resources; receiving a first white space search result for the instruction from the first terminal; and determining the D2D link resource based on the first white space search result.

The determining of the D2D link resource based on the first white space search result may include: determining a first remote terminal having the smallest interference with the D2D link among the cellular terminals based on the first white space search result; and determining cellular resources allocated to the first remote terminal as the D2D link resource.

The method may further include: receiving a white space search request from a second terminal of the at least two terminals; logging scheduling information on the cellular resources; and re-instructing the white space search to the first terminal.

The method may further include: receiving a new channel quality information report from the first terminal; logging scheduling information on the cellular resources; and re-instructing the white space search to the first terminal.

The method may further include: receiving a second white space search result for the re-instruction from the first terminal; and determining the D2D link resource based on the second white space search result.

The determining of the D2D link resource based on the second white space search result may include: determining a second remote terminal having the smallest interference with the D2D link among the cellular terminals based on the second white space search result; and determining cellular resources allocated to the second remote terminal as the D2D link resource.

Another exemplary embodiment of the present invention provides a method for allocating, by a base station, a resource to a D2D link. The method for allocating a resource includes: determining a D2D link resource to be allocated to the D2D link among cellular resources of the base station; transmitting scheduling information on the D2D link resource to base stations adjacent to the base station; receiving a response from the adjacent base stations; transmitting the scheduling information to a first terminal of at least two terminals connected by the D2D link; and transmitting uplink control information including information on the D2D link resource to the first terminal at the time of receiving a response from the first terminal.

The determining may include: instructing the first terminal to search for a white space of the cellular resources; receiving a first white space search result for the instruction from the first terminal; and determining the D2D link resource based on the first white space search result.

The determining of the D2D link resource based on the first white space search result may include: determining a first remote terminal having the smallest interference with the D2D link among the cellular terminals based on the first white space search result; and determining cellular resources allocated to the first remote terminal as the D2D link resource.

The method may further include: receiving a white space search request from the adjacent base stations; logging scheduling information on the cellular resources; and re-instructing the white space search to the first terminal, wherein the white space search request is a request which is transmitted by a second terminal of the at least two terminals.

The method may further include: receiving a new channel quality information report from the first terminal; logging scheduling information on the cellular resources; and re-instructing the white space search to the first terminal.

The method may further include: receiving a second white space search result for the re-instruction from the first terminal; and determining the D2D link resource based on the second white space search result.

The determining of the D2D link resource based on the second white space search result may include: determining a second remote terminal having the smallest interference with the D2D link among the cellular terminals based on the second white space search result; and determining cellular resources allocated to the second remote terminal as the D2D link resource.

Yet another embodiment of the present invention provides a method of transmitting and receiving data to and from adjacent terminals through a D2D link. The method for transmitting/receiving data includes: searching for a white space of cellular resources; transmitting a search result for the white space to a base station of coverage to which the terminal belongs; receiving resource information determined depending on the search result; and transmitting/receiving data to and from the adjacent terminals through the D2D link based on the resource information.

The method may further include: prior to the searching, receiving a search instruction for the white space from the base station.

The method may further include: updating channel quality information of the D2D link and transmitting the new channel quality information to the base station; receiving a re-search instruction for the white space from the base station; and re-searching for a white space of the cellular resources.

The resource information may include information on the cellular resources allocated to a remote terminal having the smallest interference with the D2D link among a plurality of cellular terminals connected to the base station.

According to an exemplary embodiment of the present invention, it is possible to use the D2D link without the performance deterioration of the existing macrocell by increasing the spatial reuse rate of the cellular frequency when some of the cellular resources are allocated to the D2D link. Further, it is possible to effectively cope with the dynamic change in wireless conditions even when the data are transmitted and received between the terminals through the D2D link.

### BRIEF DESCRIPTION OF THE DRAWINGS

FIG. 1 is a diagram illustrating a network for allocating a resource to a D2D link by a scheduler of a base station according to an exemplary embodiment of the present invention.

FIG. 2 is a flowchart illustrating a method for acquiring a resource for a D2D link in UE according to an exemplary embodiment of the present invention.

FIG. 3 is a diagram illustrating spectrum sensing results measured by the UE according to the exemplary embodiment of the present invention.

FIG. 4 is a diagram illustrating a scheduling log of a cellular mobile communication network according to an exemplary embodiment of the present invention.

FIG. 5 is a diagram illustrating a scheduling log of a D2D communication network according to an exemplary embodiment of the present invention.

FIG. 6 is a diagram illustrating a network for allocating a resource to a D2D link by schedulers of a plurality of base stations according to another exemplary embodiment of the present invention.

FIG. 7 is a flowchart illustrating a method for acquiring a resource for a D2D link in UE according to another exemplary embodiment of the present invention.

FIG. 8 is a block diagram illustrating a wireless communication system according to another exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, a mobile station (MS) may be called a terminal, a mobile terminal (MT), an advanced mobile station (AMS), a high reliability mobile station (HR-MS), a subscriber station (SS), a portable subscriber station (PSS), an access terminal (AT), user equipment (UE), and the like, and may also include all or some of the functions of the terminal, the MT, the AMS, the HR-MS, the SS, the PSS, the AT, the UE, and the like

Further, a base station (BS) may be called an advanced base station (ABS), a high reliability base station (HR-BS), a node B, an evolved node B (eNodeB), an access point (AP), a radio access station (RAS), a base transceiver station (BTS), a mobile multihop relay (MMR)-BS, a relay station (RS) serving as the base station, a relay node (RN) serving as the base station, an advanced relay station (ARS) serving as the base station, a high reliability relay station (HR-RS) serving as the base station, small base stations (a femto base station (femto BS), a home node B (HNB), a home eNodeB (HeNB), a pico base station (pico BS), a metro base station (metro BS), a micro base station (micro BS), and the like), and the like, and may also include all or some of the functions of the ABS, the HR-BS, the nodeB, the eNodeB, the AP, the RAS, the BTS, the MMR-BS, the RS, the RN, the ARS, the HR-RS, the small base stations, and the like.

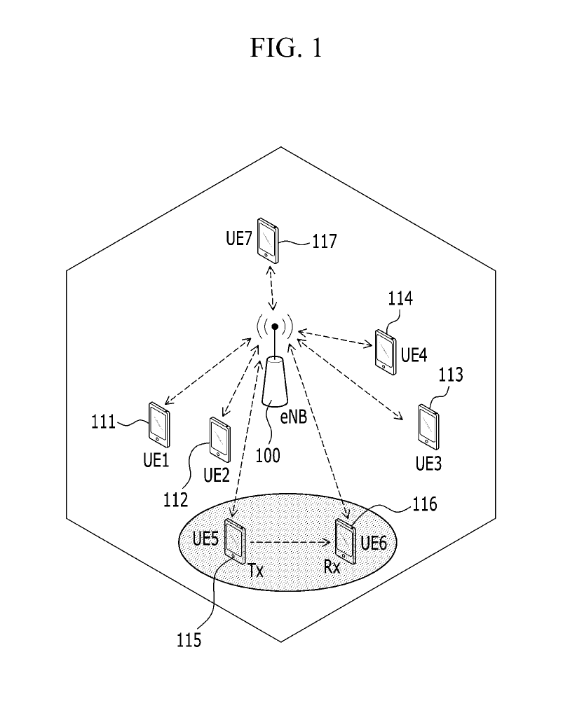

FIG. 1 is a diagram illustrating a network for allocating a resource to a D2D link by a scheduler of a base station according to an exemplary embodiment of the present invention.

Referring to FIG. 1, seven UEs UE1 to UE7 are connected to one base station 100 (eNodeB, eNB). A scheduler of the base station 100 allocates uplink/downlink resources to UEs which are connected to the base station 100, in which each UE may transmit and receive data to and from the base station through the allocated resources.

In this case, since UE5 115 and UE6 116 are adjacent to each other, when intending to directly transmit and receive data through the D2D link, the scheduler of the base station 100 needs to allocate resources to the D2D link from the existing cellular uplink resources allocated to a cell. In this case, as a link which may give interference to the D2D link which will be generated between the UE5 115 and UE6 116, there are an uplink from UE1 111, UE2 112, UE3 113, UE4 114, and UE7 117 to the base station 100, and an uplink from the UE5 115 and the UE6 116 to the base station 100.

When a traffic load of a current cell is not so high, the remaining uplink resources may be distributed to the D2D link. However, when the traffic load of the current cell is high or a policy to inhibit the D2D link from affecting uplink resources of a cellular itself is applied, UE which does not give interference to the D2D link may be understood and the uplink resources allocated to the UE may be distributed to the D2D link.

Referring to FIG. 1, compared with the uplink for the base station 100 of the UE1 111, the UE2 112, the UE3 113, and the UE4 114, the uplink for the base station 100 of the UE7 117 less gives interference to the D2D link between the UE5 115 and the UE6 116. Therefore, the scheduler of the base station 100 may reallocate the uplink resources allocated to the UE117 to the D2D link between the UE5 115 and UE6 116. According to the exemplary embodiment of the present invention, a terminal which is far away from the D2D link to give less interference to the D2D link is called a remote UE (RUE). In FIG. 1, the UE7 117 may be an RUE. According to the exemplary embodiment of the present invention, the RUE may be selected as the terminal which is far away from the D2D link, but even though a terminal is not farthest away from the D2D link, the terminal may be selected as the RUE depending on a frequency and surrounding environment.

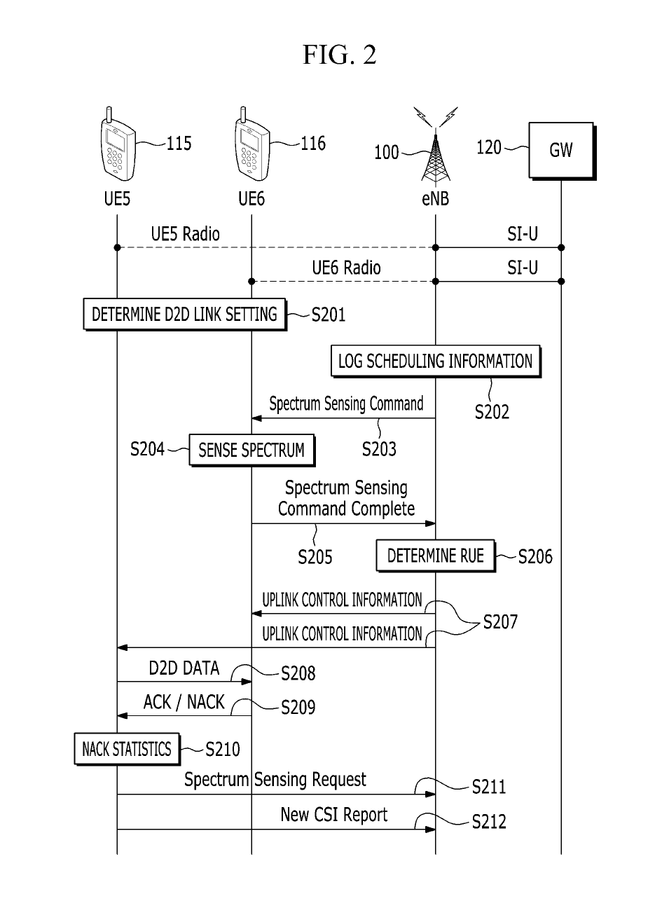

FIG. 2 is a flowchart illustrating a method for acquiring resources for a D2D link in UE according to an exemplary embodiment of the present invention.

Referring to FIGS. 1 and 2, the UE5 115 and the UE6 116 assure cellular traffic paths using the base station 100. In FIG. 2, the cellular traffic path of the UE5 115 is gateway (GW) 120 [symbol] S1-U [symbol] base station (eNB) [symbol] UE5 115, and the cellular traffic path of the UE6 116 is GW [symbol] S1-U [symbol] eNB [symbol] UE6 116.

The UE115 and the UE6 116 confirm that they are adjacent to each other and determine to set a D2D link from the UE5 to UE6 116 (S201). In this case, the UE5 115 and the UE6 116 confirm proximity to each other through complicated procedures, and the setting of the D2D link is determined by the network which receives help from each UE. According to the exemplary embodiment of the present invention, the D2D link between the UEs may be set through the eNB. The eNB instructs the UE5 115 to transmit a proximity signal and instructs the UE6 116 to receive the proximity signal. Alternatively, the eNB instructs the UE6 116 to transmit the proximity signal and instructs the UE5 115 to receive the proximity signal. Alternatively, at least two UEs determined to be adjacent to each other may transmit the proximity signal to each other and receive the proximity signal of the opponent from each other. Next, the eNB may receive a result from the UE receiving the proximity signal to confirm the proximity of the UE5 115 and the UE6 116 and allocate the D2D resource from cellular resources.

A method for determining the setting of the D2D link and then allocating a resource to the D2D link according to the exemplary embodiment of the present invention will be described in detail.

When the setting of the D2D link is determined, a media access control (MAC) layer of the base station 100 logs scheduling information (S202). The base station 100 transmits information on the D2D link to the UE5 115 and the UE6 116 through a RRCConnectionReconfiguration message and holds scheduling information on each UE in advance

In this case, the scheduling information is history information on the resources allocated to each UE among a physical resource block (PRB) of the cellular resources. That is, in the present step, the MAC layer of the base station may log the scheduling information for mapping interference information with the scheduling information.

Further, the base station 100 transmits a spectrum sensing command to the UE6 116 which is a receiving terminal (Rx part) of the D2D link. In this case, the spectrum sensing means a method for searching a general white space or a non-general white space which is used in a cognitive radio technology.

The UE6 116 which receives the spectrum sensing command scans the cellular uplink resource to measure non-interference (0) and interference (1) at a resource block (RB) or a resource block group (RBG) level (S204). Next, the UE6 116 which performs the spectrum sensing transmits the spectrum sensing results measured for each RB or RBG to the base station 100, along with the measured time information (system frame number (SFN) or subframe) (spectrum sensing command complete) (S205).

For example, it is assumed that the base station 100 allocates PRB1 of No. N frame at a specific time to the UE1 111 and allocates PRB2 to the UE2 112. In this case, the base station 100 may appreciate whether the PRB1 and the PRB2 are used, based on HARQ ACK/NACK of No. N+4 frame

Therefore, the base station may appreciate whether No. M−4 frame is used based on HARQ ACK/NACK of a current timing (No. M frame)

In this case, the base station may leave the cellular resources previously allocated to the UE alone and let the resources allocated to the RUE for the UE formed with the D2D link be reused in the D2D link.

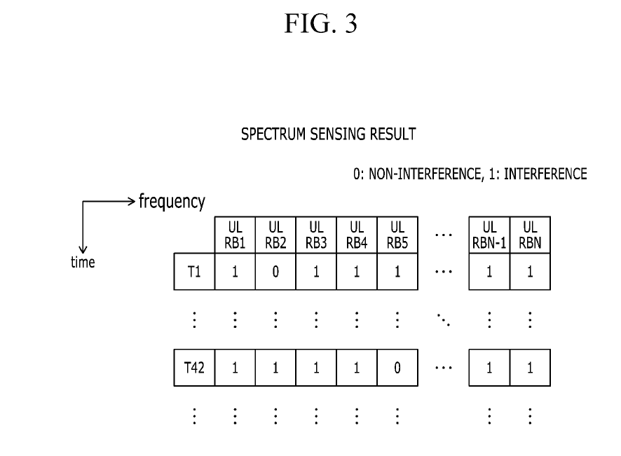

FIG. 3 is a diagram illustrating spectrum sensing results measured by the UE according to the exemplary embodiment of the present invention.

Referring to FIG. 3, the UE6 116 starts the spectrum sensing at timing T₁. FIG. 3 illustrates spectrum sensing results measured for each RB of the uplink. The interference is not present only in the RB2 of the uplink at timing T₁.

The base station 100 receiving the spectrum sensing results from the UE6 116 determines the RUE based on the spectrum sensing results of the UE6 116 and the previously logged scheduling information (S206). That is, the base station 100 finds out the time T₁ when the UE16 116 starts the spectrum sensing from the previously logged scheduling information and searches to which UE the RB representing no interference at the timing T₁ is allocated. For example, the UE matched in this step may be the UE7 of FIG. 1.

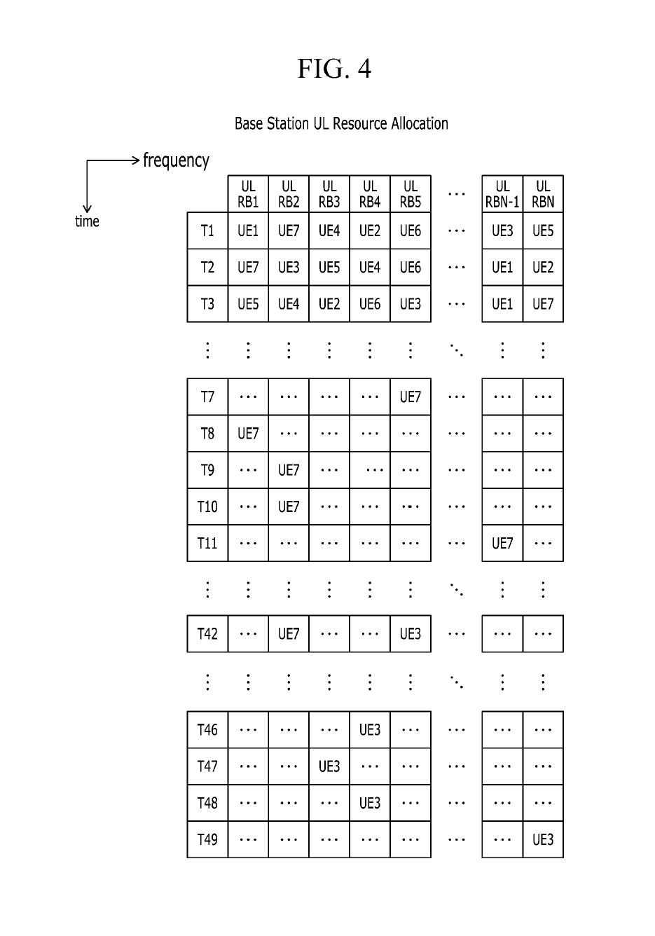

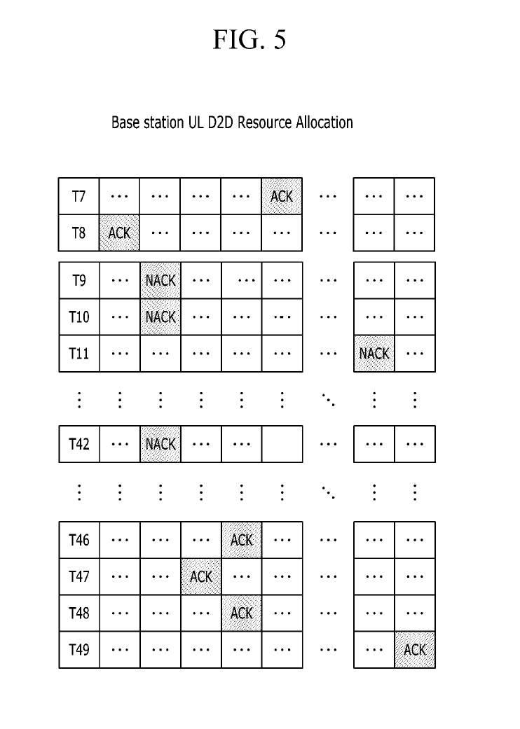

FIG. 4 is a diagram illustrating a scheduling log of a cellular mobile communication network according to an exemplary embodiment of the present invention, and FIG. 5 is a diagram illustrating a scheduling log of a D2D communication network according to an exemplary embodiment of the present invention.

Reviewing the “base station uplink resource allocation (eNB UL resource allocation)” of FIG. 4, the UE using the RB2 at the timing T₁ is the UE7 and therefore the UE7 may be the RUE.

Referring to FIG. 2, the base station 100 transmits the uplink link control information (CI) to the UE5 115 and the UE6 116 (S207). The uplink CI includes information on the cellular uplink resources which are allocated to the D2D link.

Next, the UE5 115 receiving the uplink CI writes the D2D data in the cellular uplink resources allocated to the D2D link and the UE6 116 reads the D2D data from the same cellular uplink resources (S208). Further, the UE6 116 reads D2D data and then transmits ACK/NACK to the UE5 115 (S209). When steps S208 and S209 are repeated, it may be considered that the D2D link from the UE5 115 to the UE6 116 is formed.

Reviewing the “base station uplink resource allocation” of FIG. 4, the resources for the D2D link are not allocated up to timing T₇ when the uplink CI is applied. However, from the T₇, the cellular uplink resources allocated to the UE7 determined as the RUE are allocated as the resources of the D2D link. That is, like the “base station uplink D2D resource allocation (eNB UL D2D Resource Allocation)” of FIG. 5, the scheduler of the base station 100 allocates the RB allocated to the uplink of the UE7 to the D2D link at each timing.

In FIG. 5, the ACK/NACK transmitted from the UE6 116 to the UE5 115 is represented in the RB allocated to the D2D link. It may be appreciated from FIG. 4 that ACK is transmitted at timings T₇ and T₈ but NACK is much transmitted at timing T₉ to T₁₁, from which it may be determined that interference occurs in the corresponding RB as time passes.

According to the exemplary embodiment of the present invention, the transmitting terminal (e.g., UE5) of the D2D link may collect the NACK transmitted from the receiving terminal (e.g., UE6) to compile statistics, and may determine whether the spectrum sensing of the receiving terminal is again required based on the statistics of the NACK (S210). If it is determined that the spectrum sensing of the D2D link is required again, the transmitting terminal transmits the spectrum sensing request to the base station 100 (S211).

Further, according to another exemplary embodiment of the present invention, the receiving terminal (MAC of UE6) of the D2D link may again design channel quality information (CQI) to report a new CQI report to the base station 100 (S212).

When the base station 100 receives the spectrum sensing request from the UE5 115 or receives the new CQI report from the UE6 116, the base station 100 again logs the scheduling information and re-instructs the UE6 116 to perform the spectrum sensing so as to determine another RUE which does not give interference to the D2D link.

Referring to FIG. 3, as a channel condition or communication environment is changed, the spectrum sensing result at timing T₄₂ is different from that at timing T₁. The spectrum sensing result of FIG. 3 represents that no interference is present in RB5 of the uplink at the timing T₄₂.

Next, when the UE6 116 transmits the spectrum sensing result in which the RB5 is 0 to the base station 100, the base station 100 searches which UE is allocated to the RB5 at timing T₄₂ from the previous scheduling log. It may be appreciated from FIG. 4 that the RB5 at timing T₄₂ is allocated with the UE3. Therefore, the RUE is changed from the UE7 to the UE3 and the base station 100 allocates the RB allocated to the uplink of the UE3 to the D2D link.

Next, at timing T₄₆, the base station 100 transmits the RB allocated to the uplink of the UE3 through the uplink CI of a content allocating the RB to the D2D link between the UE5 115 and the UE6 116 to the UE5 115 and the UE6 116, respectively. Further, after the timing T₄₆, the UE5 115 may transmit data to the UE6 116 through the RB allocated to the uplink of the UE3, and at the same time, the UE6 116 may receive data from the UE5 115 through the RB allocated to the uplink of the UE3. Further, the UE5 115 calculates the NACK statistics from the UE6 116 and the UE116 reports the CQI to the base station 100.

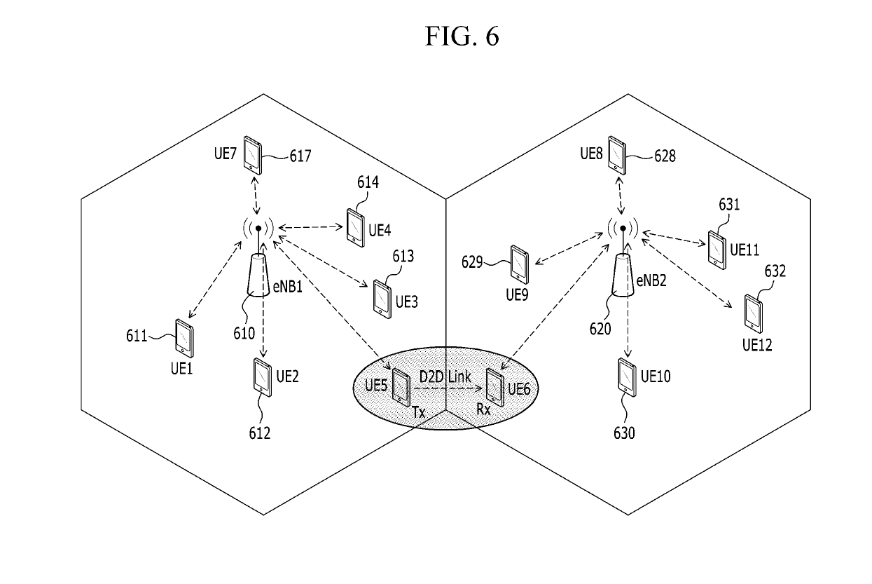

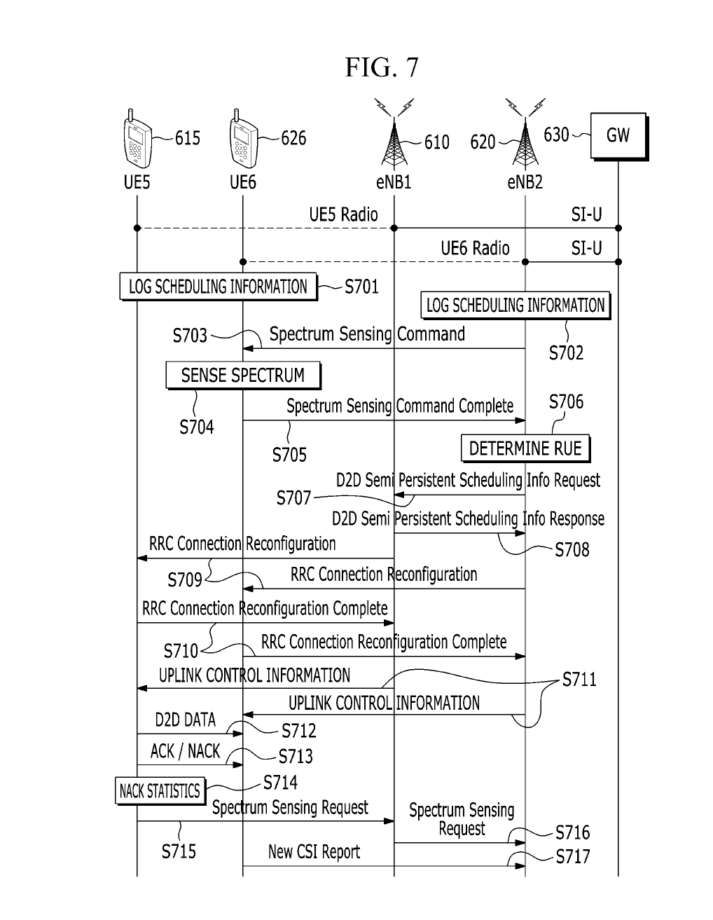

FIG. 6 is a diagram illustrating a network for allocating a resource to a D2D link by schedulers of a plurality of base stations according to another exemplary embodiment of the present invention, and FIG. 7 is a flowchart illustrating a method for acquiring resources for a D2D link in UE according to another exemplary embodiment of the present invention.

Referring to FIG. 6, the UE5 615 is allocated with the resources from the scheduler of base station 1 (eNB1) 610, and the UE6 626 is allocated with resources from the scheduler of base station 2 (eNB2) 620. That is, the UE5 615 and the UE6 626 secure the cellular traffic paths by different base stations and different schedulers.

Referring to FIG. 7, the cellular traffic path of the UE5 615 is the cellular traffic path of GW 630 [symbol] S1-U [symbol] base station 1 (610, eNB1) [symbol] UE5 615, and the cellular traffic path of the UE6 626 is GW 630 [symbol] S1-U [symbol] eNB2 [symbol] UE6 626.

The UE5 615 and the UE6 626 confirm that they are adjacent to each other and determine to set a D2D link from the UE5 615 to UE6 626 (S701). As illustrated in FIG. 2, according to the exemplary embodiment of the present invention, a method for allocating a resource to the D2D link which is a subsequent procedure to a procedure of determining the setting of the D2D link will be described in detail.

When the setting of the D2D link is determined, the MAC layer of the base station 2 620 which is connected to the receiving terminal (i.e., UE6) of the D2D link is connected to the scheduling information (S702). Further, base station 2 620 transmits the spectrum sensing command to the UE6 626 (S703).

The UE6 626 receiving the spectrum sensing command scans the cellular uplink resource to measure non-interference 0 and interference 1 at a level of RB or RBG (S704). Next, the UE6 626 performing the spectrum sensing transmits the spectrum sensing results measured for each RB or each RBG to the base station 2 620, along with measured time information (sfn or subframe) (S705). In this case, according to the exemplary embodiment of the present invention, the spectrum sensing results transmitted from the UE6 626 to the base station 2 620 are called a spectrum sensing command complete message.

The base station 2 620 receiving the spectrum sensing command complete message from the UE6 626 determines the RUE based on the spectrum sensing results and the previously logged scheduling information (S706). That is, the base station 2 620 determines the time when the UE6 626 starts the spectrum sensing from the previously logged scheduling information and searches to which UE the RB representing no interference at the starting time of the spectrum sensing is allocated.

When the base station 2 620 determines RUE from the UE included in coverage, the uplink resources are allocated to the RUE by a semi-persistent scheduling (SPS) method, in consideration of the current service level of the RUE and capacity of the D2D link. That is, the base station may use SPS which is a method for allocating resources of voice over LTE (VoLTE) to adaptively determine the D2D link resources depending on a cell load. For example, when a current cell load is 40%, the base station may allocate the rest of the resources of 60% to the D2D link resource and may not give interference even to a D2D link of adjacent base stations. The scheduler of the base station 2 620 may determine the following four scheduling information based on an SPS method.
Starting point (e.g., SFN) at which the SPS is applied
subframe number where the allocated resources is positioned (e.g., when a duration of the radio frame is 10 ms and the radio resource is allocated in a subframe unit of 1 ms, 10 bitmaps 0 to 9 are provided as the subframe number. For example, when [1, 0, 0, 1, 0, 0, 1, 0, 1, 0] is provided as the bitmap, resources of Nos. 0, 3, 6, and 8 subframes are allocated. In this case, when colliding with transmission having high priority like system information, the subframe is not allocated with resources)
Frequency domain information (if necessary, for example, when 20 RBs are present on a frequency basis, 20 bit maps are provided)
SPS period (unit is millisecond)

Next, the base station 2 620 transmits the scheduling information to the base station 1 610 as a D2D SPS information request (D2DSemiPersistentSchedulingRequest) message (S707). A signal may be transmitted/received between the base station 1 610 and the base station 2 620 through an x2 interface or an s1 interface.

The base station 1 610 inhibits the uplink resource corresponding to the scheduling information included in the D2D SPS information request message from being used in the cellular uplink. In this case, the inhibition timing may be the SPS starting point. Further, the base station 1 610 transmits the D2D SPS information response (D2DSemiPersistentSchedulingResponse) message, including yes/no for the D2D SPS information request message (S708). In this case, when a D2D SPS information response message DP YES is included, the base station 1 610 and the base station 2 620 ensure that the SPS scheduling is performed at the previously defined SPS starting point. According to the exemplary embodiment of the present invention, the base station 1 610 and the base station 2 620 may share the resource to be allocated to the D2D link and the starting point of the SPS, that is, activation time when the SPS is performed.

Next, base station 1 610 and base station 2 620 inform the UE5 615 and the UE6 626 of the D2D link, respectively, of the scheduling information of the D2D SPS information request message (RRCConnectionReconfiguration) (S709). Further, the base station 1 610 and the base station 2 620 receive a response for the RRC Connection Reconfiguration from the UE5 615 and the UE6 626 (RRCConnectionReconfigurationComplete) (S710). That is, according to the exemplary embodiment of the present invention, the base station 1 610 and the base station 2 620 exchange the RRCConnectionReconfiguration message and the RRCConnectionReconfigurationComplete message with the UE5 615 and the UE6 626, thereby transmitting the D2D link setting information to the UE.

Next, at the previously defined SPS activation time, the MACs of the base station 1 610 and the base station 2 620 transmit the uplink CI of a content that the resources are allocated to the D2D link to the UE5 615 and the UE6 626 (S711). At this time, the uplink CI for the D2D link is transmitted from each base station to each UE only once. That is, the D2D link may be allocated with resources depending on the SPS scheduling and may be periodically maintained, and therefore it is sufficient that the base station transmits the uplink CI once.

The UE5 615 receiving the uplink CI from the base station 1 610 writes the data in the resources allocated through the uplink CI, and the UE6 626 receiving the uplink CI from the base station 2 620 reads the data from the resources allocated through the uplink CI (S712). Further, the UE6 626 reads the D2D data and then transmits the ACK/NACK to the UE5 615 (S713).

In this case, according to the exemplary embodiment of the present invention in FIG. 2, the transmitting terminal (e.g., UE5 615) of the D2D link may collect the NACK transmitted from the receiving terminal (e.g., UE6) to compile statistics, and may determine whether the spectrum sensing of the receiving terminal is again required based on the statistics of the NACK (S714). Further, if it is determined that the spectrum sensing needs to be performed at the receiving terminal of the D2D link again, the transmitting terminal (UE5 615) transmits the spectrum sensing request to the base station 1 610 (S715). When the base station 1 610 receives the spectrum sensing request from the transmitting terminal, the base station 1 610 transmits the spectrum sensing request to the base station 2 620 (S716). Alternatively, the UE6 626 may design the new CQI to report the new CQI report to the base station 2 620 (S717).

Next, when the base station 2 620 receives the spectrum sensing request dispatched from the UE5 615 or receives the new CQI report from the UE6 626, the base station 2 620 may instruct the UE6 626 to again perform the spectrum sensing, and may determine another RUE which does not give interference to the D2D link based on the spectrum sensing result which is performed again.

According to another exemplary embodiment of the present invention, the case in which the overall resources of the cell are fully loaded is rare, and therefore resources may be allocated to the D2D link based on the remaining uplink resources. Further, in the case in which the D2D link is formed between the UEs which are located at different cells, the method for allocating SPS uplink resources may also be used as described in FIG. 7. In addition, the method for allocating a resource to a bidirectional D2D link may be implemented by changing the method for allocating a resource to a one-way D2D link as described above.

As described above, according to an exemplary embodiment of the present invention, it is possible to use the D2D link without the performance deterioration of the existing macrocell by increasing the spatial reuse rate of the cellular frequency when some of the cellular resources are allocated to the D2D link. Further, it is possible to effectively cope with the dynamic change in wireless conditions even when the data are transmitted and received between the terminals through the D2D link.

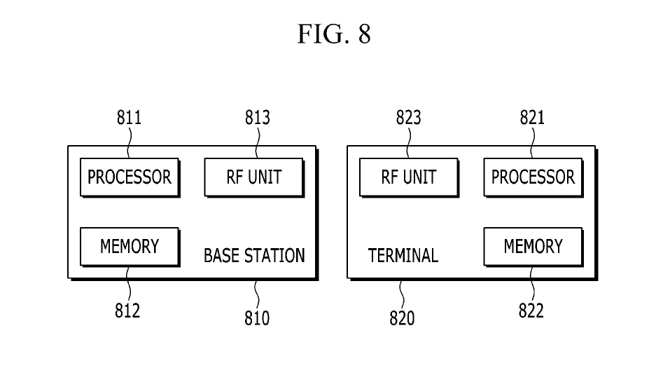

FIG. 8 is a block diagram illustrating a wireless communication system according to another exemplary embodiment of the present invention.

Referring to FIG. 8, the wireless communication system according to the exemplary embodiment of the present invention includes a base station 810 and a terminal 820.

The base station 810 includes a processor 811, a memory 812, and a radio frequency (RF) unit 813. The memory 812 is connected with the processor 811 to store various information for driving the processor 811. The RF unit 813 is connected with the processor 811 to transmit and/or receive a radio signal. The processor 811 may implement a function, a process, and/or a method which are proposed in the present invention. In this case, in the wireless communication system according to the exemplary embodiment of the present invention, a radio interface protocol layer may be implemented by the processor 811. An operation of the base station 810 according to the exemplary embodiment of the present invention may be implemented by the processor 811.

The terminal 820 includes a processor 821, a memory 822, and an RF unit 823. The memory 822 is connected with the processor 821 to store various information for driving the processor 821. The RF unit 823 is connected with the processor 821 to transmit and/or receive the radio signal. The processor 821 may implement a function, a process, and/or a method which are proposed in the present invention. In this case, in the wireless communication system according to the exemplary embodiment of the present invention, the radio interface protocol layer may be implemented by the processor 821. An operation of the terminal 820 according to the exemplary embodiment of the present invention may be implemented by the processor 821.

In the exemplary embodiment of the present invention, the memory may be positioned inside or outside the processor, and the memory may be connected with the processor through various already known means. The memory is various types of volatile or non-volatile storage media, and the memory may include, for example, a read-only memory (ROM) or a random access memory (RAM).

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for allocating, by a base station, a resource to a device to device (D2D) link, comprising:
determining a D2D link resource to be allocated to the D2D link among cellular resources of the base station; and
transmitting uplink control information including information on the D2D link resource to at least two terminals which are connected by the D2D link among a plurality of cellular terminals connected to the base station.

2. The method of claim 1, wherein the determining includes:
instructing a first terminal of the at least two terminals to search for a white space of the cellular resources;
receiving a first white space search result for the instruction from the first terminal; and
determining the D2D link resource based on the first white space search result.

3. The method of claim 2, wherein the determining of the D2D link resource based on the first white space search result includes:
determining a first remote terminal having the smallest interference with the D2D link among the cellular terminals based on the first white space search result; and
determining cellular resources allocated to the first remote terminal as the D2D link resource.

4. The method of claim 3, further comprising:
receiving a white space search request from a second terminal of the at least two terminals;
logging scheduling information on the cellular resources; and
re-instructing the white space search to the first terminal.

5. The method of claim 3, further comprising:
receiving a new channel quality information report from the first terminal;
logging scheduling information on the cellular resources; and
re-instructing the white space search to the first terminal.

6. The method of claim 4, further comprising:
receiving a second white space search result for the re-instruction from the first terminal; and
determining the D2D link resource based on the second white space search result.

7. The method of claim 6, wherein the determining of the D2D link resource based on the second white space search result includes:
determining a second remote terminal having the smallest interference with the D2D link among the cellular terminals based on the second white space search result; and
determining cellular resources allocated to the second remote terminal as the D2D link resource.

8. A method for allocating, by a base station, a resource to a device to device (D2D) link, comprising:
determining a D2D link resource to be allocated to the D2D link among cellular resources of the base station;
transmitting scheduling information on the D2D link resource to base stations adjacent to the base station;
receiving a response from the adjacent base stations;
transmitting the scheduling information to a first terminal of at least two terminals connected by the D2D link; and
transmitting uplink control information including information on the D2D link resource to the first terminal at the time of receiving a response from the first terminal.

9. The method of claim 8, wherein the determining includes:
instructing the first terminal to search for a white space of the cellular resources;
receiving a first white space search result for the instruction from the first terminal; and
determining the D2D link resource based on the first white space search result.

10. The method of claim 9, wherein the determining of the D2D link resource based on the first white space search result includes:
determining a first remote terminal having the smallest interference with the D2D link among cellular terminals based on the first white space search result; and
determining cellular resources allocated to the first remote terminal as the D2D link resource.

11. The method of claim 10, further comprising:
receiving a white space search request from the adjacent base stations;
Logging the scheduling information on the cellular resources; and
re-instructing the white space search to the first terminal,
wherein the white space search request is a request which is transmitted by a second terminal of the at least two terminals.

12. The method of claim 10, further comprising:
receiving a new channel quality information report from the first terminal;
logging the scheduling information on the cellular resources; and
re-instructing the white space search to the first terminal.

13. The method of claim 11, further comprising:
receiving a second white space search result for the re-instruction from the first terminal; and
determining the D2D link resource based on the second white space search result.

14. The method of claim 13, wherein the determining of the D2D link resource based on the second white space search result includes:
determining a second remote terminal having the smallest interference with the D2D link among the cellular terminals based on the second white space search result; and
determining cellular resources allocated to the second remote terminal as the D2D link resource.

15. A method for transmitting/receiving, by a terminal, data to and from adjacent terminals through a device to device (D2D) link, comprising:
searching for a white space of cellular resources;
transmitting a search result for the white space to a base station of coverage to which the terminal belongs;
receiving resource information determined depending on the search result; and
transmitting/receiving data to and from the adjacent terminals through the D2D link based on the resource information.

16. The method of claim 15, further comprising, prior to the searching, receiving a search instruction for the white space from the base station.

17. The method of claim 16, further comprising:
updating channel quality information of the D2D link and transmitting the new channel quality information to the base station;
receiving a re-search instruction for the white space from the base station; and
re-searching for the white space of the cellular resources.

18. The method of claim 15, wherein the resource information
includes information on the cellular resources allocated to a remote terminal having the smallest interference with the D2D link among a plurality of cellular terminals connected to the base station.
